(19) United States
(12) Patent Application Publication
(10) Pub. No.: US 2005/0199356 A1
(43) Pub. Date: Sep. 15, 2005

(54) Drapery shade

(76) Inventors: Ming Nien, Changhua Hsien (TW); Julio Liu, Las Condes (CL)

Correspondence Address: BIRCH STEWART KOLASCH & BIRCH, PO BOX 747, FALLS CHURCH, VA, 22040-0747, US

(21) Appl. No.: 10/901,200

(22) Filed: Jul. 29, 2004

(30) Foreign Application Priority Data
Mar. 12, 2004 (TW) 093203864

(51) Int. Cl. E06B 9/08

(52) U.S. Cl. 160/348

(57) ABSTRACT

A drapery shade includes a shade having a top and a bottom, two tieback sets and two fastening units. The two tieback sets are vertically suspended near two opposite lateral sides of the shade. Each tieback set has a first belt vertically suspended from the top of the shade at a front side relative to the shade, and a second belt vertically suspended from the top of the shade at a back side relative to the shade. The two fastening units are disposed respectively at the two tieback sets for coupling the first belts of the tieback sets to the second belts of the tieback sets to support the bottom of the shade at a desired elevation.

### BACKGROUND OF THE INVENTION

1. Field of the Invention

The present invention relates to a drapery shade and more particularly, to such a drapery shade that can easily be adjusted to a desired elevation.

2. Description of the Related Art

FIG. 1 shows a drapery shade according to the prior art. According to this design, the drapery shade comprises a shade 1 fixedly fastened to a headrail, and two tieback sets 2 provided at the left and right sides and vertically downwardly suspended from the top side of the shade 1. The tieback sets 2 each are comprised of a first cord member 3 and a second cord member 4 respectively provided at the front and back sides of the shade 1. When adjusting the elevation of the drapery shade, as shown in FIG. 2, the first cord member 3 and second cord member 4 of each tieback set 2 are tied into a knot (for example, butterfly-knot) at the desired elevation, thereby forming a support to support the bottom side of the shade 1 at the desired elevation.

The method of tying the cord members 3, 4 into a knot to support the bottom side of the shade 1 at the desired elevation has drawbacks as follows:

1. Complicated elevation adjustment procedure: When adjusting the elevation of the shade, the user must tie the two cord members of one tieback set into a knot and then tie the two cord members of the other tieback set into a knot. The tied knot must be easily unfastenable. Normally, the two cord members of each tieback set are tied into a butterfly-knot. The sense of beauty of the drapery shade is affected, if the two butterfly-knots at the two tieback sets are not symmetrical.

2. High elevation control difficulty: It is not easy to accurately tie the two cord members of each tieback set into a knot at the desired elevation. This problem is more serious in a big scale drapery shade. If the knots at the tieback sets of the drapery shade are not horizontally aligned, the user may have to untie the knots and then tie the cord members again.

3. Easy sliding of the bottom of the shade: The tieback sets can be tied up to give a support to the bottom of the shade in vertical direction; however, they cannot prohibit the bottom of the shade from sliding sideways. If the bottom of the shade is not kept in balance, the drapery shade cannot cause a sense of beauty.

### SUMMARY OF THE INVENTION

It is the primary objective of the present invention to provide a drapery shade, which can easily be adjusted to a desired elevation.

It is another objective of the present invention to provide a drapery shade, which has the tieback sets provided with detachable ornamental knots for easy replacement.

It is still another objective of the present invention to provide a drapery shade, which prevents transverse sliding of the bottom of the shade.

To achieve these objectives of the present invention, the drapery shade comprises a shade having a top and a bottom, two tieback sets and two fastening units. The two tieback sets are vertically suspended near two opposite lateral sides of the shade. Each tieback set has a first belt vertically suspended from the top of the shade at a front side relative to the shade, and a second belt vertically suspended from the top of the shade at a back side relative to the shade. The two fastening units are disposed respectively at the two tieback sets for coupling the first belts of the tieback sets to the second belts of the tieback sets to support the bottom of the shade at a desired elevation.

In an embodiment of the present invention, the fastening unit comprises a plurality of stud members that are provided at a back side of the first belt of the tieback set, and a plurality of socket members that are provided at a front side of the second belt of the tieback set and are couplable to the stud members.

In another embodiment of the present invention, the fastening unit comprises an elongated hook tape of a hook and loop fastener, which is longitudinally attached to the back side of the first belt, and an elongated loop tape of the hook and loop fastener, which is longitudinally attached to the front side of the second belt and couplable to the hook tape.

In still another embodiment of the present invention, the fastening unit comprises a hook tape of a hook and loop fastener, which is attached to an ornament that is sleeved onto the first belt, and an elongated loop tape of the hook and loop fastener, which is attached to the front side of the second belt for coupling the hook tape.

In still another embodiment of the present invention, the fastening unit is a belt buckle for fastening the first and second belts.

In still another embodiment of the present invention, the fastening unit comprises an ornamental body and two tie belts provided at the ornamental body for tying the first and second belts of the tieback set.

### BRIEF DESCRIPTION OF THE DRAWINGS

FIG. 1 is a perspective view of a drapery shade according to the prior art, showing fully extended status of the shade.

FIG. 2 is another perspective view of the prior art drapery shade, showing the bottom of the shade adjusted to a predetermined elevation.

FIG. 3 is a perspective view of a drapery shade according to a first preferred embodiment of the present invention, showing the bottom of the shade adjusted to a predetermined elevation.

FIG. 4 is an enlarged view of a part of the first preferred embodiment of the present invention, showing coupling of the ornament to the first belt of one tieback set.

FIG. 5 is a sectional view of a part of the first preferred embodiment of the present invention, showing the first belt and second belt of one tieback set fastened together.

FIG. 6 is a perspective view of a drapery shade according to a second preferred embodiment of the present invention, showing the bottom of the shade adjusted to a predetermined elevation.

FIG. 7 is a perspective view of one ornament for use in the second preferred embodiment of the present invention.

FIG. 8 is a side view in an enlarged scale of a part of the second preferred embodiment of the present invention, showing the relationship between the first belt and the second belt.

FIG. 9 is a perspective view of a drapery shade according to a third preferred embodiment of the present invention, showing the bottom of the shade adjusted to a predetermined elevation.

FIG. 10 is a perspective view of a fastener (belt buckle) for use in the third preferred embodiment of the present invention.

FIG. 11 is an enlarged view of a part of the third embodiment of the present invention, showing the fastener (belt buckle) fastened to the first belt and the second belt.

FIG. 12 is a perspective view of a drapery shade according to a fourth preferred embodiment of the present invention, showing the bottom of the shade adjusted to a predetermined elevation.

FIG. 13 is a perspective view of a fastener for use in the fourth embodiment of the present invention.

FIG. 14 is an enlarged view of a part of the fourth preferred embodiment of the present invention, showing fastening of the fastener to the first belt and the second belt.

FIG. 15 is a perspective view of a fastener for use in a fifth preferred embodiment of the present invention.

FIG. 16 is a perspective view of a fastener for use in a sixth preferred embodiment of the present invention.

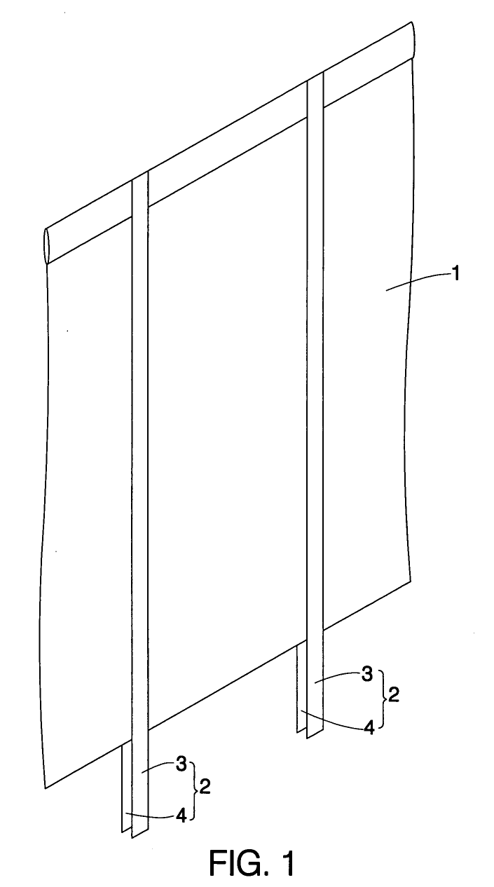

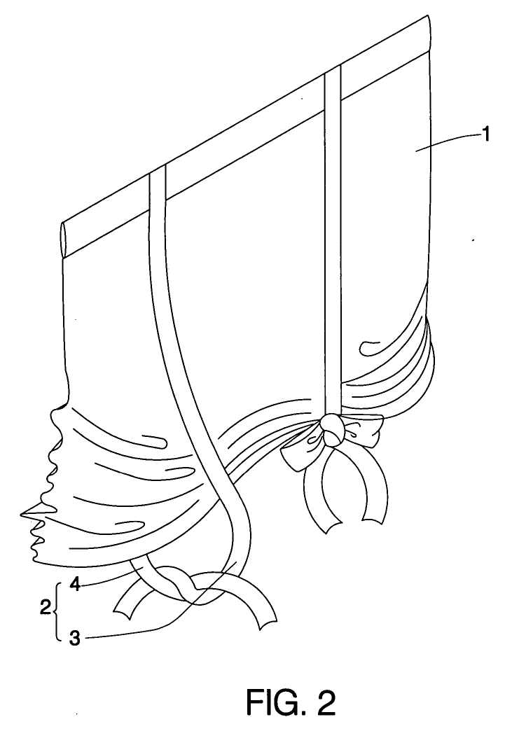

### DETAILED DESCRIPTION OF THE INVENTION

The above objectives, features and other advantages of the present invention will be more clearly understood from the following detailed description taken in conjunction with the accompanying drawings.

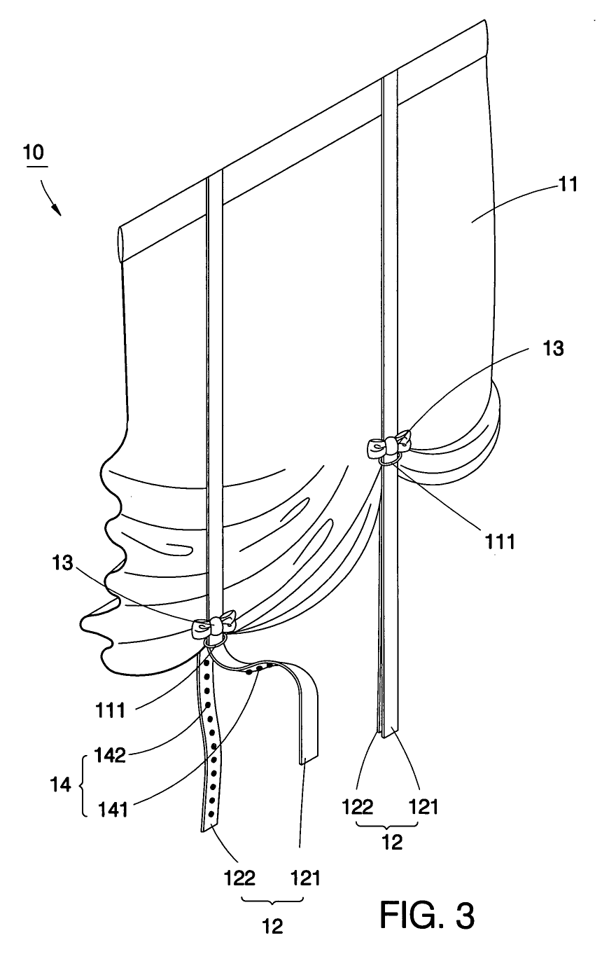

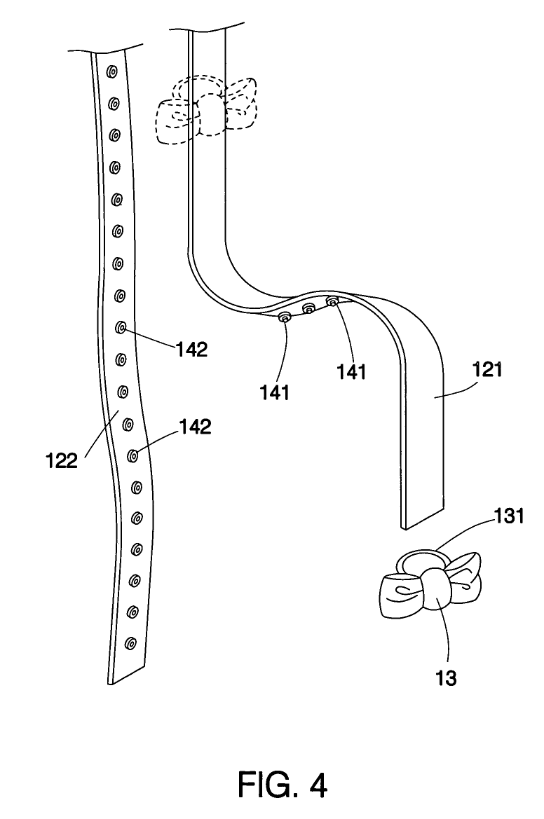

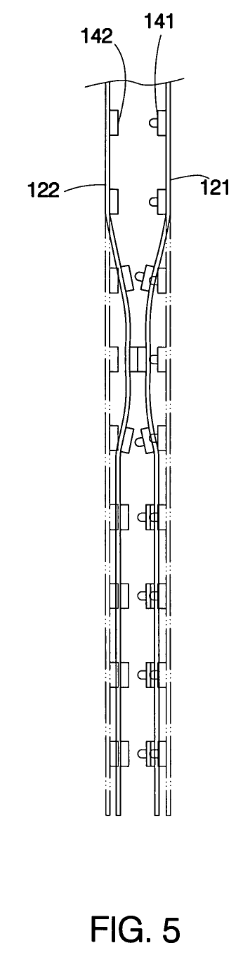

Referring to FIGS. 3-5, a drapery shade 10 in accordance with the first preferred embodiment of the present invention is shown comprised of a shade 11, two tieback sets 12, two ornaments 13, and two fastening units 14.

The shade 11 has the top thereof fixedly fastened to a headrail at the top side of a window (not shown), and the front side of the bottom thereof provided with two belt loops 111. The two belt loops 111 are equally spaced from the midpoint of the bottom of the shade 11 at a distance.

The two tieback sets 12 are vertically disposed near the two sides of the shade 11 corresponding to the belt loops 111, each comprised of a first belt 121 and a second belt 122. The first belt 121 and the second belt 122 are vertically downwardly suspended from the top side of the shade 11 and respectively disposed at the front and back sides of the shade 11.

The ornaments 13 are shaped like a butterfly-knot, each having a belt loop 131 provided at the back side and sleeved onto the first belt 121 of one tieback set 12.

The fastening units 14 are respectively formed in the tieback sets 12, each comprised of a plurality of first fasteners 141 and a plurality of second fasteners 142. According to this embodiment, the first fasteners 141 are stud members provided at the back side of the first belt 121 and longitudinally aligned in a line; the second fasteners 142 are socket members provided at the front side of the second belt 122 and longitudinally aligned in a line for receiving the stub members 141.

When adjusting the elevation of the drapery shade 10, the belt loops 131 of the ornaments 13 are respectively sleeved onto the first belts 121 of the two tieback sets 12, and then the first belts 121 of the two tieback sets 12 are respectively downwardly inserted through the belt loops 111 of the shade 11, and then the bottom of the shade 11 is lifted to the desired elevation, and then the stud members 141 of the fastening units 14 below the bottom of the shade 11 are respectively fastened to the respective socket members 142 to secure the first belt 121 and second belt 122 of each tieback set 12 firmly together, supporting the bottom of the shade 11 in the desired elevation.

In practice, the fastening unit 14 can be designed comprising one first fastener and one second fastener only. For example, the first fastener is a hook tape of a hook and loop fastener, which is longitudinally provided at the back side of the first belt 121, and the second fastener is a loop tape of the hook and loop fastener, which is longitudinally provided at the front side of second belt 122 for coupling the hook tape (the first fastener).

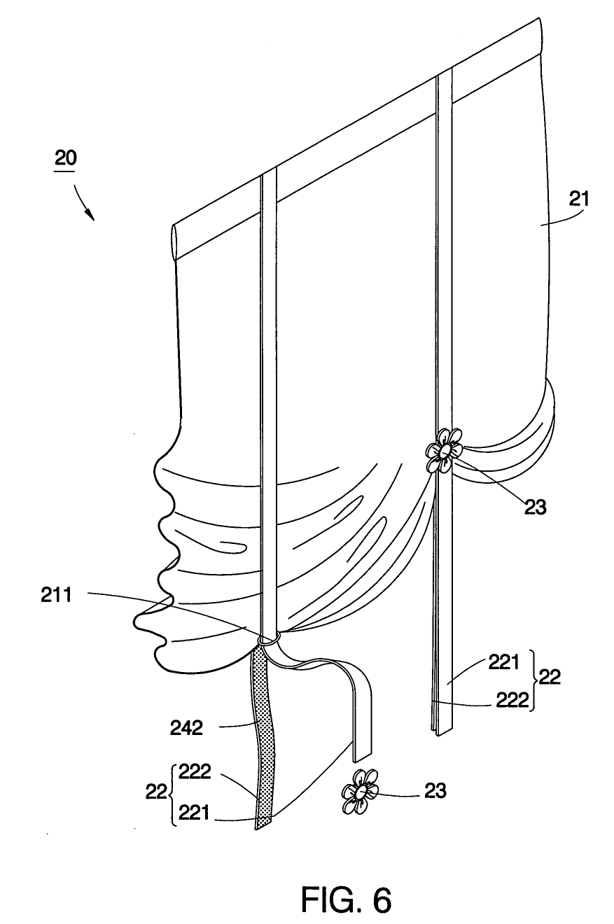

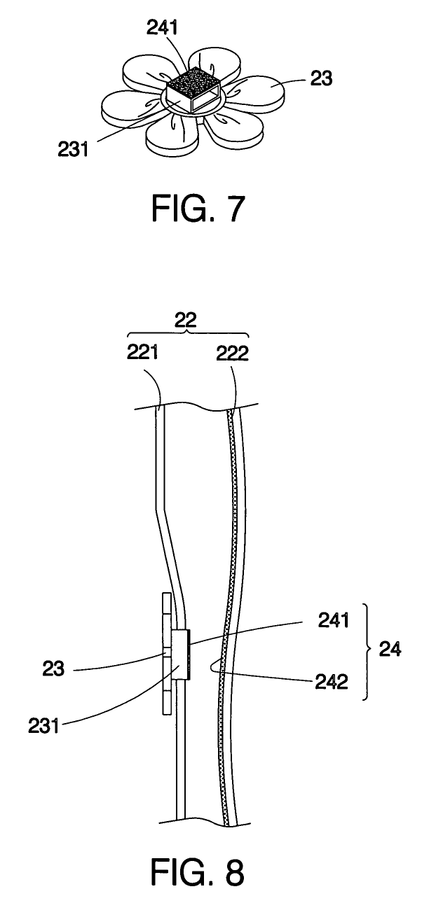

FIGS. 6-8 show a drapery shade 20 constructed according to the second preferred embodiment of the present invention. According to this embodiment, the drapery shade 20 is comprised of a shade 21, two tieback sets 22, two ornaments 23, and two fastening units 24.

The shade 21 has the top thereof fixedly fastened to a headrail at the top side of a window (not shown), and the front side of the bottom thereof provided with two belt loops 211. The two belt loops 211 are equally spaced from the midpoint of the bottom of the shade 21 at a distance.

The two tieback sets 22 are vertically disposed near the two lateral sides of the shade 21 corresponding to the belt loops 211, each comprised of a first belt 221 and a second belt 222. The first belt 221 and the second belt 222 are vertically downwardly suspended from the top side of the shade 21 and respectively disposed at the front and back sides of the shade 21.

The ornaments 23 are shaped like a flower, each having a belt loop 231 provided at the back side and sleeved onto the first belt 221 of one tieback set 22.

The fastening units 24 each comprise a first fastener 241 and a second fastener 242, which are respectively disposed at the ornaments 23 and the tieback sets 22. According to this embodiment, the first fastener 241 is a hook tape provided at the back side of the belt loop 231 of one ornament 23; the second fastener 242 is an elongated loop tape provided longitudinally at the front side of the second belt 222.

When adjusting the elevation of the drapery shade 20, the first belts 221 of the two tieback sets 22 are respectively downwardly inserted through the belt loops 211 of the shade 21, and then the belt loops 231 of the ornaments 23 are respectively sleeved onto the first belts 221 of the two tieback sets 22, and then the bottom of the shade 21 is lifted to the desired elevation, and then the hook tapes 241 of the fastening units 24 are respectively fastened to the loop tapes 242 to secure the ornaments 23 with the first belts 221 to the second belts 222 respectively, supporting the bottom of the shade 21 in the desired elevation.

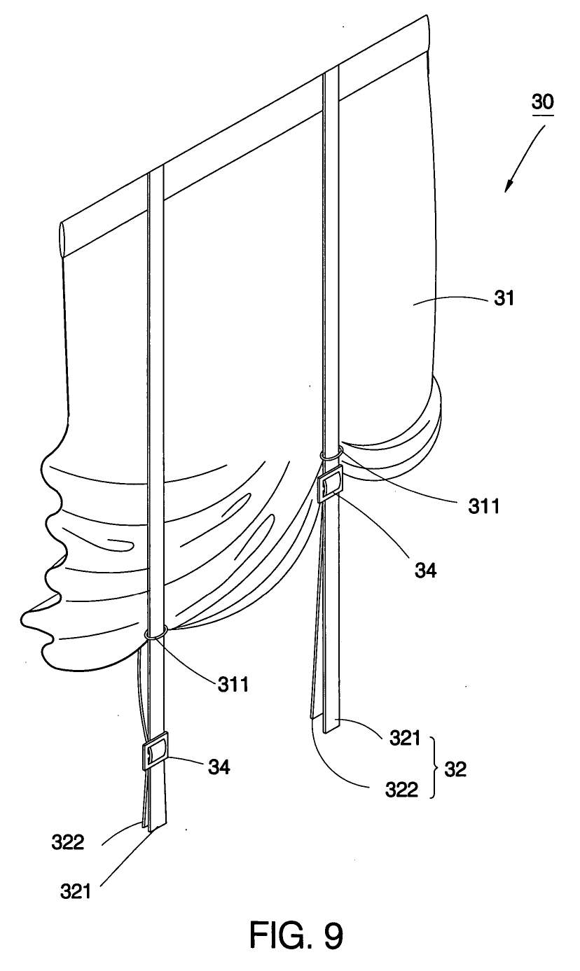

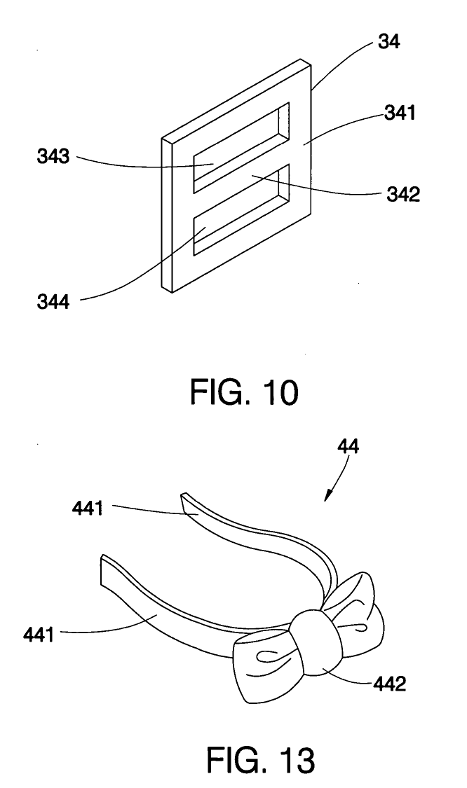

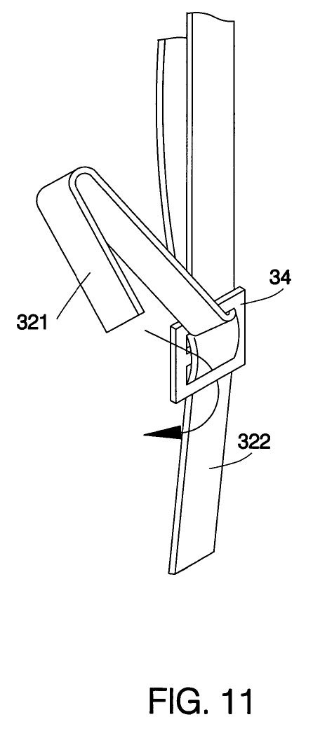

FIGS. 9-11 show a drapery shade 30 constructed according to the third embodiment of the present invention. According to this embodiment, the drapery shade 30 is comprised of a shade 31, two tieback sets 32, and two fastening units 34.

The shade 31 has the top thereof fixedly fastened to a headrail at the top side of a window (not shown), and the front side of the bottom thereof provided with two belt loops 311. The two belt loops 311 are equally spaced from the midpoint of the bottom of the shade 31 at a distance.

The two tieback sets 32 are vertically disposed near the two lateral sides of the shade 31 corresponding to the belt loops 311, each comprised of a first belt 321 and a second belt 322. The first belt 321 and the second belt 322 are vertically downwardly suspended from the top side of the shade 31 and respectively disposed at the front and back sides of the shade 31.

The fastening units 34 are belt buckles respectively fastened the tieback sets 32, each comprising a rectangular open frame 341 and a crossbar 342 transversely connected between two opposite lateral sides of the rectangular open frame 341. The crossbar 342 divides the inside space of the rectangular open frame 341 into two insertion holes 343, 344. The first belt 321 and second belt 322 of each tieback set 32 are inserted through the upper insertion hole 343 of the respective belt buckle 34 and extended over the front side of the crossbar 342, and then inserted through the lower insertion hole 343 of the respective belt buckle 34.

When adjusting the elevation of the drapery shade 30, the first belts 321 of the two tieback sets 32 are respectively downwardly inserted through the belt loops 311 of the shade 31 to prevent displacement of the bottom of the shade 31 transversely, and then the belt buckles 34 are respectively fastened to the tieback sets 32 to secure the respective first belts 321 to the respective second belts 322, and then the belt buckles 34 are adjusted relative to the tieback sets 32 to the desired elevation to support the bottom of the shade 31 at the adjusted elevation.

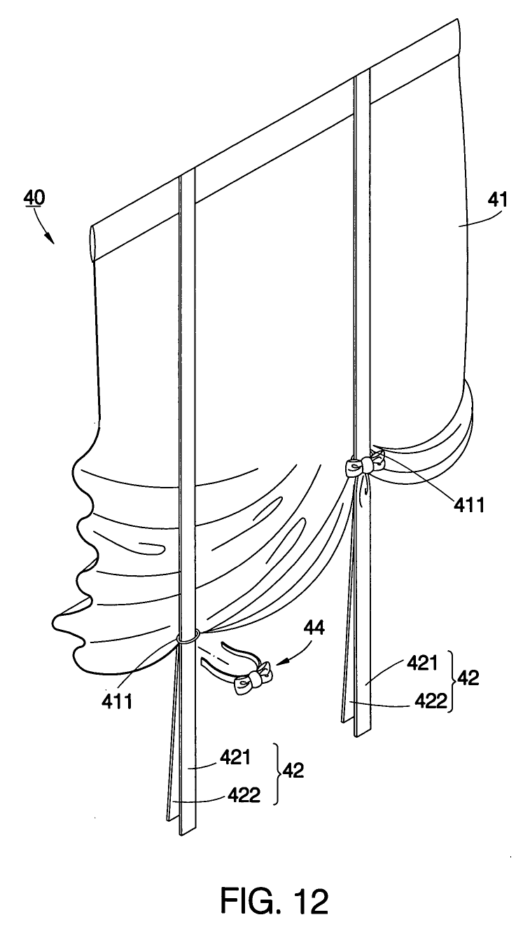

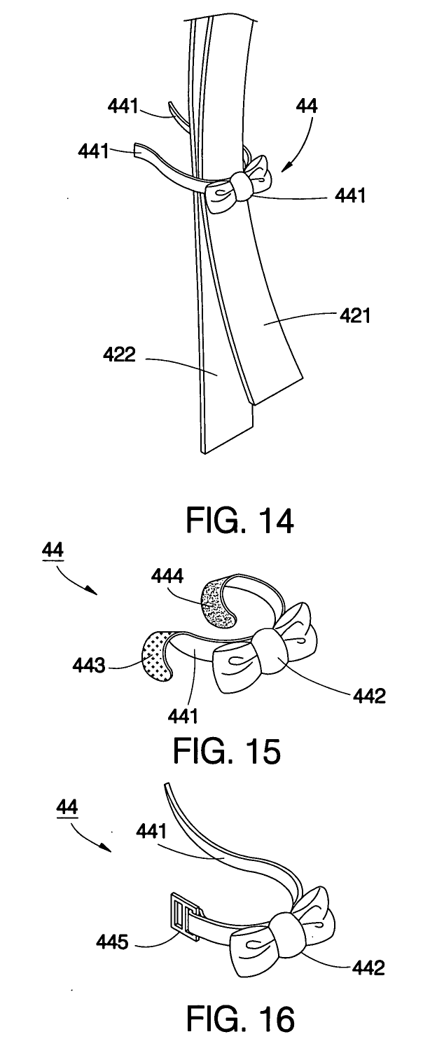

FIGS. 12-14 show a drapery shade 40 constructed according to the fourth preferred embodiment of the present invention. According to this embodiment, the drapery shade 40 is comprised of a shade 41, two tieback sets 42, and two fastening units 44.

The shade 41 has the top thereof fixedly fastened to a headrail at the top side of a window (not shown), and the front side of the bottom thereof provided with two belt loops 411. The two belt loops 411 are equally spaced from the midpoint of the bottom of the shade 41 at a distance.

The two tieback sets 42 are vertically disposed near the two opposite lateral sides of the shade 41 corresponding to the belt loops 411, each comprised of a first belt 421 and a second belt 422. The first belt 421 and the second belt 422 are vertically downwardly suspended from the top side of the shade 41 and respectively disposed at the front and back sides of the shade 41.

The fastening units 44 each are comprised of an ornament 442 and two tie belts 441 at the back side of the ornament 442. The ornament 442 can be made having any of a variety of shape, for example, the shape of a butterfly-knot. The tie belts 441 of the fastening unit 44 are used to tie up the first belt 421 and second belt 422 of the respective tieback set 42 at the desired elevation.

When adjusting the elevation of the drapery shade 40, the first belts 421 of the two tieback sets 42 are respectively downwardly inserted through the belt loops 411 of the shade 41 to prevent displacement of the bottom of the shade 41 transversely, and then the fastening units 44 are respectively fastened to the tieback sets 42 at the desired elevation to secure the respective first belts 421 to the respective second belts 422, thereby supporting the bottom of the shade 41 at the adjusted elevation.

Referring to FIG. 15, the fifth preferred embodiment of the present invention is substantially similar to the aforesaid fourth preferred embodiment with the exception of the fastening units. According to this embodiment, each fastening unit 44 comprises an ornament 442, two belts 441 at the back side of the ornament 442, a first fastener, for example, a hook tape 443 provided at one of the belts 441, and a second fastener, for example, a loop tape 444 provided at the back side of the other of the belts 441 and connectable to the hook tape 443.

Referring to FIG. 16, the sixth preferred embodiment of the present invention is substantially similar to the aforesaid fourth embodiment with the exception of the fastening units. According to this embodiment, each fastening unit 44 comprises an ornament 442, two belts 441 at the back side of the ornament 442, and a belt buckle 445 for joining the belts 441 and to secure the respective fastening unit 44 to one tieback set (not shown).

As indicated above, the advantages of the present invention includes (a) not need to tie each tieback set into a knot to support the bottom of the shade at the desired elevation, thereby simplifying the drapery shade elevation adjustment procedure; (b) having ornaments detachably coupled to the tieback sets such that the user can replace the ornaments when desired; (c) having belt loops provided at the bottom of the shade and coupled to the tieback sets to prevent transverse displacement of the bottom of the shade.

Although particular embodiments of the invention have been described in detail for purposes of illustration, various modifications and enhancements may be made without departing from the spirit and scope of the invention. Accordingly, the invention is not to be limited except as by the appended claims.

1. A drapery shade comprising:
a shade having a top and a bottom;
two tieback sets vertically suspended near two opposite lateral sides of said shade, said tieback sets each having a first belt vertically suspended from the top of said shade at a front side relative to said shade, and a second belt vertically suspended from the top of said shade at a back side relative to said shade; and
two fastening units disposed respectively at said two tieback sets for coupling the first belts of said tieback sets to the second belts of the respective tieback sets to support the bottom of said shade at a desired elevation.

2. The drapery shade as claimed in claim 1, wherein each said fastening unit comprises at least one first fastener provided at a back side of the first belt of one said tieback set, and at least one second fastener provided at a front side of the second belt of the respective tieback set for coupling said first fastener.

3. The drapery shade as claimed in claim 2, wherein each said fastening unit comprises a plurality of said first fasteners, each of which is a stud member, and a plurality of said second fasteners, each of which is a socket member couplable to said stud member.

4. The drapery shade as claimed in claim 2, wherein said first fastener is an elongated hook tape of a hook and loop fastener, which is longitudinally attached to the back side of the first belt, and said second fastener is an elongated loop tape of the hook and loop fastener, which is longitudinally attached to the front side of the second belt and couplable to said hook tape.

5. The drapery shade as claimed in claim 3, further comprising two ornaments each comprising an ornamental body and a belt loop provided at a back side of said ornamental body for insertion of one of the first belts of the tieback sets for enabling the respective ornament to be moved along the respective first belt to the desired elevation.

6. The drapery shade as claimed in claim 4, further comprising two ornaments each comprising an ornamental body and a belt loop provided at a back side of said ornamental body for insertion of one of the first belts of the tieback sets for enabling the respective ornament to be moved along the respective first belt to the desired elevation.

7. The drapery shade as claimed in claim 1, further comprising two ornaments connectable to said tieback sets, said ornaments each having an ornamental body and a belt loop provided at a back side of said ornamental body for insertion of one of the first belts of the tieback sets for enabling the respective ornament to be moved along the respective first belt to the desired elevation; wherein said two fastening units each comprise a first fastener, which is a hook tape of a hook and loop fastener and is attached to a back side of one of said belt loops of said ornaments, and a second fastener, which is an elongated loop tape of the hook and loop fastener and is attached to a front side of one of the second belts of said tieback sets for coupling said hook tape.

8. The drapery shade as claimed in claim 1, wherein said two fastening units each comprise a belt buckle, said belt buckle having a rectangular open frame and a crossbar transversely connected between two opposite lateral sides of said rectangular open frame to divide said rectangular open frame into two insertion holes.

9. The drapery shade as claimed in claim 1, wherein said two fastening units each comprise an ornament and a fastener provided at a back side of said ornament.

10. The drapery shade as claimed in claim 9, wherein said fastener is comprised of two tie belts.

11. The drapery shade as claimed in claim 10, wherein said two tie belts are respectively provided with a hook tape of a hook and loop fastener and a loop tape of the hook and loop fastener.

12. The drapery shade as claimed in claim 10, wherein one of said two tie belts is provided with a belt buckle for insertion of the other tie belt.

13. The drapery shade as claimed in claim 1, wherein said shade comprises two belt loops bilaterally provided at a front side of the bottom thereof corresponding in location to said two tieback sets.

14. A drapery shade comprising:
a shade having a top, a bottom, and two belt loops bilaterally provided at a front side of the bottom thereof; and
two tieback sets vertically suspended near two opposite lateral sides of said shade corresponding to said belt loops, said tieback sets each having a first belt vertically suspended from the top of said shade at a front side relative to said shade, and a second belt vertically suspended from the top of said shade at a back side relative to said shade.

15. The drapery shade as claimed in claim 14, further comprising two fastening units disposed respectively at said two tieback sets for coupling the first belts of said tieback sets to the second belts of the respective tieback sets to support the bottom of said shade at a desired elevation.

16. The drapery shade as claimed in claim 15, wherein each said fastening unit comprises at least one first fastener provided at a back side of the first belt of one said tieback set, and at least one second fastener provided at a front side of the second belt of the respective tieback set for coupling said first fastener.

17. The drapery shade as claimed in claim 16, wherein each said fastening unit comprises a plurality of said first fasteners, each of which is a stud member, and a plurality of said second fasteners, each of which is a socket member couplable to said stud member.

18. The drapery shade as claimed in claim 16, wherein said first fastener is an elongated hook tape of a hook and loop fastener, which is longitudinally attached to the back side of the first belt, and said second fastener is an elongated loop tape of the hook and loop fastener, which is longitudinally attached to the front side of the second belt and couplable to said hook tape.

19. The drapery shade as claimed in claim 15, wherein said two fastening units each comprise a belt buckle, said belt buckle having a rectangular open frame and a crossbar transversely connected between two opposite lateral sides of said rectangular open frame to divide said rectangular open frame into two insertion holes.

20. The drapery shade as claimed in claim 15, wherein said two fastening units each comprise an ornament and a fastener provided at a back side of said ornament.
